(19) United States
(12) Patent Application Publication
(10) Pub. No.: US 2023/0408651 A1
(43) Pub. Date: Dec. 21, 2023

(54) Spinning Lidar With One or More Secondary Mirrors

(71) Applicant: Waymo LLC, Mountain View, CA (US)

(72) Inventors: Ralph Hamilton Shepard, Menlo Park, CA (US); Blaise Gassend, East Palo Alto, CA (US)

(21) Appl. No.: 17/806,324

(22) Filed: Jun. 10, 2022

(51) Int. Cl. G01S 7/481; G01S 17/931; G01S 17/89; G01S 17/42; G01S 17/86; G01S 7/48; G01S 17/10

(52) U.S. Cl. CPC G01S 7/4817; G01S 17/931; G01S 17/89; G01S 17/10; G01S 17/86; G01S 7/4808; G01S 7/4813; G01S 17/42

(57) ABSTRACT

Example embodiments relate to spinning lidars utilizing one or more secondary mirrors. An example embodiment includes a lidar system that includes a rotatable portion. The rotatable portion includes one or more light sources and one or more one or more detectors. The rotatable portion is configured to rotate about a rotational axis such that the one or more light sources are operable to emit light within an azimuthal 360 degree field of view. The 360 degree field of view comprises a primary field of view that is less than 360 degrees. The lidar system also includes at least one secondary mirror configured to reflect light initially emitted by the one or more light sources in a direction away from the primary field of view so as to redirect the light into a secondary field of view.

### BACKGROUND

Unless otherwise indicated herein, the description in this section is not prior art to the claims in this application and is not admitted to be prior art by inclusion in this section.

Autonomous vehicles, semi-autonomous vehicles, vehicles operating in an autonomous mode, and/or vehicles operating in a semi-autonomous mode may use various sensors to detect their surroundings. For example, light detection and ranging (lidar) devices, radio detection and ranging (radar) devices, and/or cameras may be used to identify objects in environments surrounding autonomous or semi-autonomous vehicles. Such sensors may be used in object detection and avoidance and/or in navigation, for example.

Conventional rotating lidar devices may be operable to rotate about a rotational axis so as to scan light emitters and corresponding detectors through 360 degrees in azimuth. By scanning lidar devices in this manner, object and/or ranging information may be obtained from an environment of the lidar device.

However, one of the challenges associated with rotating lidar devices is that the lidar device is not always pointing toward a desired field of view. In such scenarios, conventional rotating lidar devices could be pointed toward an undesirable field of view for at least a portion of a full azimuthal rotation of the lidar. Accordingly, improved systems and methods for obtaining more lidar information about a desired field of view in a given azimuthal rotation of the lidar are desired.

### SUMMARY

The present disclosure relates to a rotating lidar system, lidar module, and method of their use so as to provide higher spatial and/or temporal resolution within a desired field of view in a given azimuthal rotation of the lidar system.

In a first aspect, a lidar system is provided. The lidar system includes a rotatable portion that includes one or more light sources and one or more detectors. The rotatable portion is configured to rotate about a rotational axis such that the one or more light sources are operable to emit light within an azimuthal 360 degree field of view. The 360 degree field of view comprises a primary field of view that is less than 360 degrees. The lidar system also includes at least one secondary mirror configured to reflect light initially emitted by the one or more light sources in a direction away from the primary field of view so as to redirect the light into a secondary field of view.

In a second aspect, a lidar module is provided. The lidar module includes a housing configured to be attached to a vehicle and a rotatable portion disposed inside the housing. The rotatable portion includes one or more light sources and one or more detectors. The rotatable portion is configured to rotate about a rotational axis such that the one or more light sources are operable to emit light within an azimuthal 360 degree field of view. The 360 degree field of view includes a primary field of view that is less than 360 degrees. The lidar module also includes at least one secondary mirror disposed inside the housing. The at least one secondary mirror is configured to reflect light initially emitted by the one or more light sources in a direction outside the primary field of view so as to redirect the light into a secondary field of view.

In a third aspect, a method is provided. The method includes causing one or more light sources of a rotatable portion of a lidar to emit light into a primary field of view. The method also includes causing the one or more light sources to emit light toward at least one secondary mirror configured to redirect the emitted light into a secondary field of view. The method optionally includes causing at least one actuator to adjust a position of the at least one secondary mirror so as to adjust a position of the secondary field of view with respect to the primary field of view. The method also optionally includes receiving information indicative of a motion. Causing the at least one actuator to adjust the position of the at least one secondary mirror is based on the received information so as to at least partially counteract the motion.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1 is a functional block diagram illustrating a vehicle, according to example embodiments.

FIG. 2A is an illustration of a physical configuration of a vehicle, according to example embodiments.

FIG. 2B is an illustration of a physical configuration of a vehicle, according to example embodiments.

FIG. 2C is an illustration of a physical configuration of a vehicle, according to example embodiments.

FIG. 2D is an illustration of a physical configuration of a vehicle, according to example embodiments.

FIG. 2E is an illustration of a physical configuration of a vehicle, according to example embodiments.

FIG. 3 is a conceptual illustration of wireless communication between various computing systems related to an autonomous vehicle, according to example embodiments.

FIG. 4A is a block diagram of a system including a lidar device, according to example embodiments.

FIG. 4B is a block diagram of a lidar device, according to example embodiments.

FIG. 5 is a block diagram of a lidar system, according to example embodiments.

FIG. 6 is an illustration of the lidar system of FIG. 5, according to example embodiments.

FIG. 7 is an illustration of a direct view operation of the lidar system of FIG. 5, according to example embodiments.

FIG. 8 is an illustration of secondary mirror operation of the lidar system of FIG. 5, according to example embodiments.

FIG. 9A is an illustration of a primary field of view and an overlapping secondary field of view, according to example embodiments.

FIG. 9B is an overhead illustration of a plurality of azimuthal scanning regions of a spinning lidar, according to example embodiments.

FIG. 9C is an illustration of light emitted into a primary field of view and an overlapping secondary field of view versus azimuth angle, according to example embodiments.

FIG. 10 is a flow chart depicting a method, according to example embodiments.

### DETAILED DESCRIPTION

Example methods and systems are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are contemplated herein. In addition, the particular arrangements shown in the figures should not be viewed as limiting. It should be understood that other embodiments might include more or less of each element shown in a given figure. Additionally, some of the illustrated elements may be combined or omitted. Yet further, an example embodiment may include elements that are not illustrated in the figures.

Lidar devices as described herein can include one or more light emitters and one or more detectors used for detecting light that is emitted by the one or more light emitters and reflected by one or more objects in an environment surrounding the lidar device. As an example, the surrounding environment could include an interior or exterior environment, such as an inside of a building or an outside of a building. Additionally or alternatively, the surrounding environment could include an interior of a vehicle. Still further, the surrounding environment could include a vicinity around and/or on a roadway. Examples of objects in the surrounding environment include, but are not limited to, other vehicles, traffic signs, pedestrians, bicyclists, roadway surfaces, buildings, terrain, etc. Additionally, the one or more light emitters could emit light into a local environment of the lidar itself. For example, light emitted from the one or more light emitters could interact with a housing of the lidar and/or surfaces or structures coupled to the lidar. In some cases, the lidar could be mounted to a vehicle, in which case the one or more light emitters could be configured to emit light that interacts with objects within a vicinity of the vehicle. Further, the light emitters could include optical fiber amplifiers, laser diodes, light-emitting diodes (LEDs), among other possibilities.

A lidar system may include a rotating portion that could be configured to provide a 360-degree field of view about a given rotational axis. In some embodiments, the rotating portion may include light sources and detectors that may be rotated about a substantially vertical rotational axis so as to move the light sources and detectors so as to provide a “scan” that progresses along azimuthal angles (e.g., primary beams). Alternatively, the rotating portion may be rotated about a substantially horizontal rotational axis so as to scan the light sources and detectors to provide a scan that progresses along elevation angles.

In some applications, it may be desirable to have a high resolution region of interest (e.g., looking near straight ahead) and one or more adjacent, lower resolution, wider field of view regions (e.g., to either side of the high resolution region).

In such scenarios, a desired field of view could include, for example, a 120 degree field of view in azimuth (e.g., pointing toward a “front” direction). However, rotating lidars may suffer from a relatively low utilization while the rotating portion is pointed away from the desired field of view. In such scenarios, given a 120 degree field of view, a conventional rotating lidar may spend ⅔ of its time idle.

In the present disclosure, light pulses initially directed away from the desired field of view (e.g., light pulses emitted while the rotating portion of the lidar is pointed away from the desired field of view) could be redirected by one or more secondary mirrors so that the light pulses are emitted into the desired field of view. The secondary mirror(s) could be placed outside the desired field of view and could be used to redirect beams that are shot in some “backwards-facing” directions. In some embodiments, the mirrors could be angled in such a way that the redirected shots (e.g., secondary beams) may spatially interlace with the shots emitted while the rotatable portion of the lidar is pointing forwards. In this manner, the resolution in a portion of the region of interest can be increased without increasing the number of transmit-receive channels in the lidar, yielding better performance at virtually the same cost. In some embodiments, the light pulse could be directed in such a manner to provide three times the spatial resolution across a central portion of the region of interest (e.g., 20 degree central field of view). Other angular ranges are possible for the wide field of view and higher resolution narrow field of view.

In some embodiments, the lidar system may include a housing and a lens element. The lens element may include a main lens, which the light pulses may be transmitted through as they propagate into the environment. In such a scenario, in an effort to obtain and maintain optical alignment, the secondary mirror(s) could be registered with respect to the rotating lidar and lens element in a predetermined manner. For example, the secondary mirror(s) could be coupled to a common substrate or housing by way of a first registration structure (e.g., datum pin or stop). Similarly, the rotating lidar could be coupled to the common substrate or housing by way of a second registration structure. Furthermore, the substrate or housing could be aligned or registered with the lens element. In such a manner, the secondary mirror(s) could be angled or otherwise arranged in a desired position with respect to the rotating lidar and lens element.

In some examples, accurately orienting the secondary mirrors could be performed by actively measuring the orientation of the secondary mirror(s) while in operation. As an example, light pulses emitted directly or nearly perpendicular to the secondary mirror(s) produce a very intense return, allowing the direction of the mirror normal to be estimated. Once the normal direction is known, an actuator, set screw, or another type of fine positioning mechanism could be used to adjust the position (e.g., pitch, roll, translation) of the secondary mirror in order to provide the desired spatial interlacing.

In another embodiment, the secondary mirror(s) could be dynamically actuated so as to compensate for vibration or other types of movement of the lidar system. In some cases, the lidar system may be mounted to a vehicle or another type of moving body. In such scenarios, the secondary mirror(s) could be actuated in response to motion (e.g., pitching in elevation angle) of the vehicle. As an example, a gyroscope or an inertial measurement unit could provide information indicative of an undesirable vibration or movement. In response, a controller could cause a mechanical actuator (e.g., a linear actuator or servomechanism) to adjust a position (e.g., orientation angle and/or pointing direction) of the secondary mirror(s) so as to maintain the alignment of the secondary beams with respect to the primary beams within the high-resolution portion of the field of view.

Example embodiments may additionally or alternatively include dynamically actuating the secondary mirror(s) so as to direct the secondary beams toward a steerable secondary field of view. In some examples, the desired secondary field of view could be based on an object in the environment. For example, in response to determining another vehicle in the environment, the secondary field of view could be steered so as to track the vehicle within the environment. Other types of objects are possible and contemplated.

In yet another embodiment, the secondary mirror(s) could be dynamically actuated so as to adjust a position of the high resolution portion of the field of view based on a dynamically changing orientation of the lidar. As an example, in the case of a lidar system coupled to a moving vehicle, if the moving vehicle traveling along a road crests the top of a hill, the secondary mirrors could be angled so as to move the secondary beam downwards within the primary field of view so as to adjust the high-resolution field of view downward so as to track the downhill road and corresponding objects on or near the road.

The following description and accompanying drawings will elucidate features of various example embodiments. The embodiments provided are by way of example, and are not intended to be limiting. As such, the dimensions of the drawings are not necessarily to scale.

Example systems within the scope of the present disclosure will now be described in greater detail. An example system may be implemented in or may take the form of an automobile. Additionally, an example system may also be implemented in or take the form of various vehicles, such as cars, trucks (e.g., pickup trucks, vans, tractors, tractor trailers, etc.), motorcycles, buses, airplanes, helicopters, drones, lawn mowers, earth movers, boats, submarines, all-terrain vehicles, snowmobiles, aircraft, recreational vehicles, amusement park vehicles, farm equipment or vehicles, construction equipment or vehicles, warehouse equipment or vehicles, factory equipment or vehicles, trams, golf carts, trains, trolleys, sidewalk delivery vehicles, robot devices, etc. Other vehicles are possible as well. Further, in some embodiments, example systems might not include a vehicle.

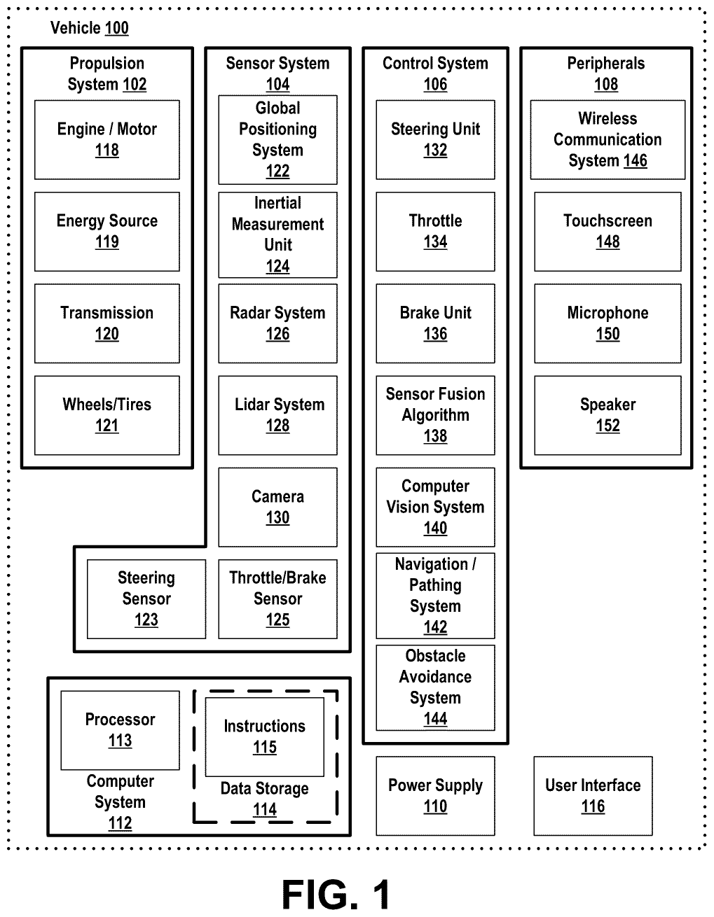

Referring now to the figures, FIG. 1 is a functional block diagram illustrating example vehicle 100, which may be configured to operate fully or partially in an autonomous mode. More specifically, vehicle 100 may operate in an autonomous mode without human interaction through receiving control instructions from a computing system. As part of operating in the autonomous mode, vehicle 100 may use sensors to detect and possibly identify objects of the surrounding environment to enable safe navigation. Additionally, example vehicle 100 may operate in a partially autonomous (i.e., semi-autonomous) mode in which some functions of the vehicle 100 are controlled by a human driver of the vehicle 100 and some functions of the vehicle 100 are controlled by the computing system. For example, vehicle 100 may also include subsystems that enable the driver to control operations of vehicle 100 such as steering, acceleration, and braking, while the computing system performs assistive functions such as lane-departure warnings/lane-keeping assist or adaptive cruise control based on other objects (e.g., vehicles, etc.) in the surrounding environment.

As described herein, in a partially autonomous driving mode, even though the vehicle assists with one or more driving operations (e.g., steering, braking and/or accelerating to perform lane centering, adaptive cruise control, advanced driver assistance systems (ADAS), emergency braking, etc.), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods are described below in conjunction with autonomous vehicles, these or similar systems and methods can be used in various driver assistance systems that do not rise to the level of fully autonomous driving systems (i.e. partially autonomous driving systems). In the United States, the Society of Automotive Engineers (SAE) have defined different levels of automated driving operations to indicate how much, or how little, a vehicle controls the driving, although different organizations, in the United States or in other countries, may categorize the levels differently. More specifically, the disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway, etc.) conditions. Likewise, the disclosed systems and methods can be used in vehicles that use SAE Level 4 self-driving systems that operate autonomously under most regular driving situations and require only occasional attention of the human operator. In all such systems, accurate lane estimation can be performed automatically without a driver input or control (e.g., while the vehicle is in motion, etc.) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

As shown in FIG. 1, vehicle 100 may include various subsystems, such as propulsion system 102, sensor system 104, control system 106, one or more peripherals 108, power supply 110, computer system 112 (which could also be referred to as a computing system) with data storage 114, and user interface 116. In other examples, vehicle 100 may include more or fewer subsystems, which can each include multiple elements. The subsystems and components of vehicle 100 may be interconnected in various ways. In addition, functions of vehicle 100 described herein can be divided into additional functional or physical components, or combined into fewer functional or physical components within embodiments. For instance, the control system 106 and the computer system 112 may be combined into a single system that operates the vehicle 100 in accordance with various operations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, an electric motor, steam engine, or Stirling engine, among other possible options. For instance, in some embodiments, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118, etc.). For instance, energy source 119 can correspond to gasoline, diesel, other petroleum-based fuels, propane, other compressed gas-based fuels, ethanol, solar panels, batteries, and/or other sources of electrical power. In some embodiments, energy source 119 may include a combination of fuel tanks, batteries, capacitors, and/or flywheels.

Transmission 120 may transmit mechanical power from engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example embodiments. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, radar 126, lidar 128, camera 130, steering sensor 123, and throttle/brake sensor 125, among other possible sensors. In some embodiments, sensor system 104 may also include sensors configured to monitor internal systems of the vehicle 100 (e.g., O2 monitor, fuel gauge, engine oil temperature, brake wear, etc.).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar 126 may represent one or more systems configured to use radio signals to sense objects, including the speed and heading of the objects, within the surrounding environment of vehicle 100. As such, radar 126 may include antennas configured to transmit and receive radio signals. In some embodiments, radar 126 may correspond to a mountable radar configured to obtain measurements of the surrounding environment of vehicle 100.

Lidar 128 may include one or more laser sources, a laser scanner, and one or more detectors, among other system components, and may operate in a coherent mode (e.g., using heterodyne detection, etc.) or in an incoherent detection mode (i.e., time-of-flight mode). In some embodiments, the one or more detectors of the lidar 128 may include one or more photodetectors, which may be especially sensitive detectors (e.g., avalanche photodiodes, etc.). In some examples, such photodetectors may be capable of detecting single photons (e.g., single-photon avalanche diodes (SPADs), etc.). Further, such photodetectors can be arranged (e.g., through an electrical connection in series, etc.) into an array (e.g., as in a silicon photomultiplier (SiPM), etc.). In some examples, the one or more photodetectors are Geiger-mode operated devices and the lidar includes subcomponents designed for such Geiger-mode operation.

Camera 130 may include one or more devices (e.g., still camera, video camera, a thermal imaging camera, a stereo camera, a night vision camera, etc.) configured to capture images of the surrounding environment of vehicle 100.

Steering sensor 123 may sense a steering angle of vehicle 100, which may involve measuring an angle of the steering wheel or measuring an electrical signal representative of the angle of the steering wheel. In some embodiments, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, an angle of a gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve, a carburetor, etc.). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other embodiments, throttle/brake sensor 125 may be configured to measure a pressure applied to a pedal of the vehicle, such as a throttle or brake pedal.

Control system 106 may include components configured to assist in navigating vehicle 100, such as steering unit 132, throttle 134, brake unit 136, sensor fusion algorithm 138, computer vision system 140, navigation/pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some embodiments, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some embodiments, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software (e.g., a general purpose processor such as a central processing unit (CPU), a specialized processor such as a graphical processing unit (GPU) or a tensor processing unit (TPU), an application-specific integrated circuit (ASIC), a field programmable gate array (FPGA), a volatile memory, a non-volatile memory, one or more machine-learned models, etc.) operable to process and analyze images in an effort to determine objects that are in motion (e.g., other vehicles, pedestrians, bicyclists, animals, etc.) and objects that are not in motion (e.g., traffic lights, roadway boundaries, speedbumps, potholes, etc.). As such, computer vision system 140 may use object recognition, Structure From Motion (SFM), video tracking, and other algorithms used in computer vision, for instance, to recognize objects, map an environment, track objects, estimate the speed of objects, etc.

Navigation/pathing system 142 may determine a driving path for vehicle 100, which may involve dynamically adjusting navigation during operation. As such, navigation/pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, interior microphone 150, and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may wirelessly communicate with one or more devices directly or via a communication network. For example, wireless communication system 146 could use 3G cellular communication, such as code-division multiple access (CDMA), evolution-data optimized (EVDO), global system for mobile communications (GSM)/general packet radio service (GPRS), or cellular communication, such as 4G worldwide interoperability for microwave access (WiMAX) or long-term evolution (LTE), or 5G. Alternatively, wireless communication system 146 may communicate with a wireless local area network (WLAN) using WIFI® or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some embodiments. For instance, power supply 110 may include one or more batteries configured to provide electrical power. Vehicle 100 may also use other types of power supplies. In an example embodiment, power supply 110 and energy source 119 may be integrated into a single energy source.

Vehicle 100 may also include computer system 112 to perform operations, such as operations described therein. As such, computer system 112 may include at least one processor 113 (which could include at least one microprocessor) operable to execute instructions 115 stored in a non-transitory, computer-readable medium, such as data storage 114. In some embodiments, computer system 112 may represent a plurality of computing devices that may serve to control individual components or subsystems of vehicle 100 in a distributed fashion.

In some embodiments, data storage 114 may contain instructions 115 (e.g., program logic, etc.) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, control system 106, etc.), as well as from user interface 116. For example, computer system 112 may utilize input from sensor system 104 in order to estimate the output produced by propulsion system 102 and control system 106. Depending upon the embodiment, computer system 112 could be operable to monitor many aspects of vehicle 100 and its subsystems. In some embodiments, computer system 112 may disable some or all functions of the vehicle 100 based on signals received from sensor system 104.

The components of vehicle 100 could be configured to work in an interconnected fashion with other components within or outside their respective systems. For instance, in an example embodiment, camera 130 could capture a plurality of images that could represent information about a state of a surrounding environment of vehicle 100 operating in an autonomous or semi-autonomous mode. The state of the surrounding environment could include parameters of the road on which the vehicle is operating. For example, computer vision system 140 may be able to recognize the slope (grade) or other features based on the plurality of images of a roadway. Additionally, the combination of GPS 122 and the features recognized by computer vision system 140 may be used with map data stored in data storage 114 to determine specific road parameters. Further, radar 126 and/or lidar 128, and/or some other environmental mapping, ranging, and/or positioning sensor system may also provide information about the surroundings of the vehicle.

In other words, a combination of various sensors (which could be termed input-indication and output-indication sensors) and computer system 112 could interact to provide an indication of an input provided to control a vehicle or an indication of the surroundings of a vehicle.

In some embodiments, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors.

Although FIG. 1 shows various components of vehicle 100 (i.e., wireless communication system 146, computer system 112, data storage 114, and user interface 116) as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

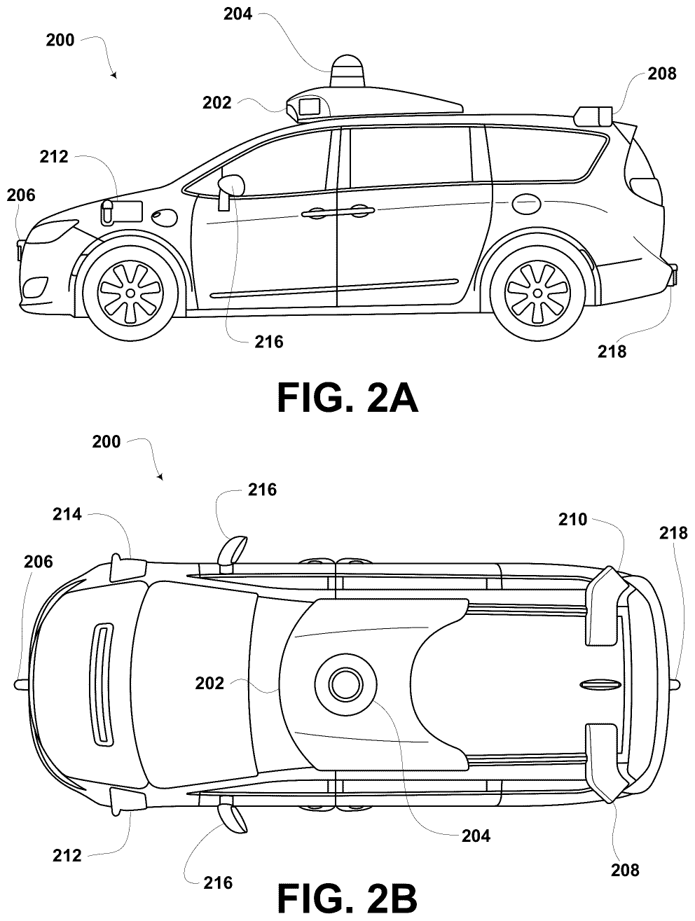

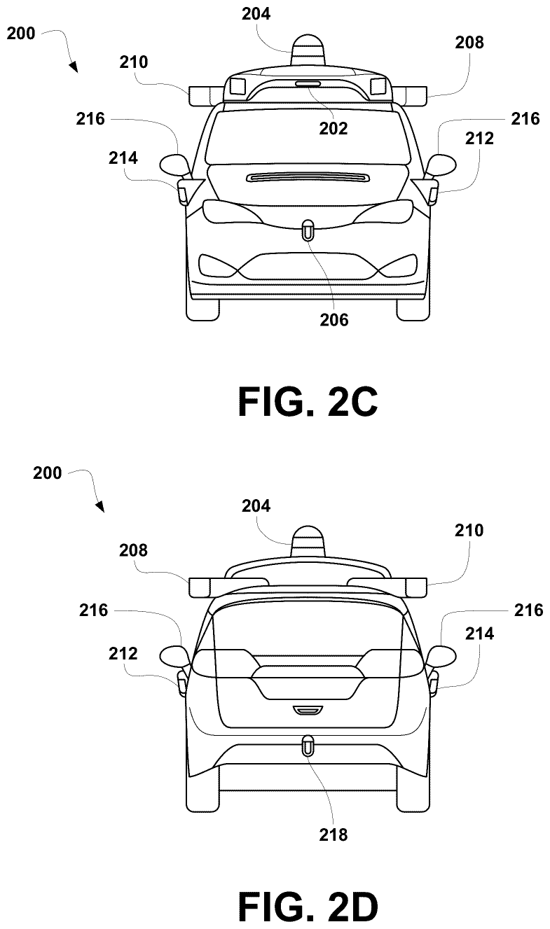

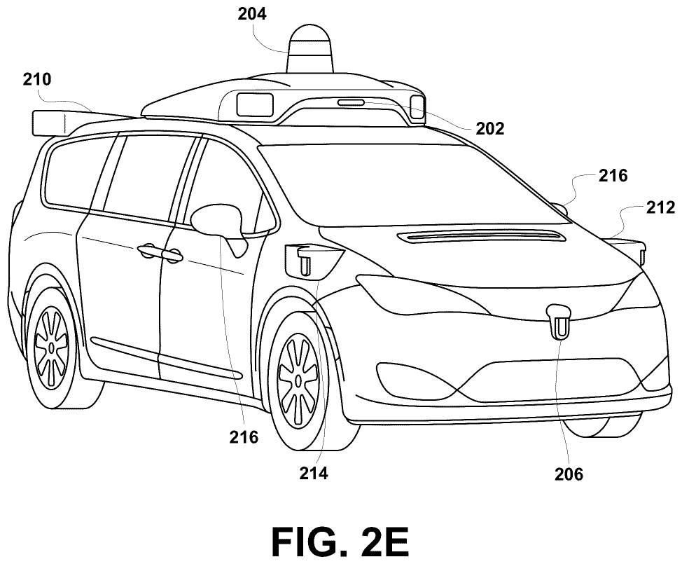

FIGS. 2A-2E show an example vehicle 200 (e.g., a fully autonomous vehicle or semi-autonomous vehicle, etc.) that can include some or all of the functions described in connection with vehicle 100 in reference to FIG. 1. Although vehicle 200 is illustrated in FIGS. 2A-2E as a van with side view mirrors for illustrative purposes, the present disclosure is not so limited. For instance, the vehicle 200 can represent a truck, a car, a semi-trailer truck, a motorcycle, a golf cart, an off-road vehicle, a farm vehicle, or any other vehicle that is described elsewhere herein (e.g., buses, boats, airplanes, helicopters, drones, lawn mowers, earth movers, submarines, all-terrain vehicles, snowmobiles, aircraft, recreational vehicles, amusement park vehicles, farm equipment, construction equipment or vehicles, warehouse equipment or vehicles, factory equipment or vehicles, trams, trains, trolleys, sidewalk delivery vehicles, and robot devices, etc.).

The example vehicle 200 may include one or more sensor systems 202, 204, 206, 208, 210, 212, 214, and 218. In some embodiments, sensor systems 202, 204, 206, 208, 210, 212, 214, and/or 218 could represent one or more optical systems (e.g. cameras, etc.), one or more lidars, one or more radars, one or more inertial sensors, one or more humidity sensors, one or more acoustic sensors (e.g., microphones, sonar devices, etc.), or one or more other sensors configured to sense information about an environment surrounding the vehicle 200. In other words, any sensor system now known or later created could be coupled to the vehicle 200 and/or could be utilized in conjunction with various operations of the vehicle 200. As an example, a lidar could be utilized in self-driving or other types of navigation, planning, perception, and/or mapping operations of the vehicle 200. In addition, sensor systems 202, 204, 206, 208, 210, 212, 214, and/or 218 could represent a combination of sensors described herein (e.g., one or more lidars and radars; one or more lidars and cameras; one or more cameras and radars; one or more lidars, cameras, and radars; etc.).

Note that the number, location, and type of sensor systems (e.g., 202, 204, etc.) depicted in FIGS. 2A-E are intended as a non-limiting example of the location, number, and type of such sensor systems of an autonomous or semi-autonomous vehicle. Alternative numbers, locations, types, and configurations of such sensors are possible (e.g., to comport with vehicle size, shape, aerodynamics, fuel economy, aesthetics, or other conditions, to reduce cost, to adapt to specialized environmental or application circumstances, etc.). For example, the sensor systems (e.g., 202, 204, etc.) could be disposed in various other locations on the vehicle (e.g., at location 216, etc.) and could have fields of view that correspond to internal and/or surrounding environments of the vehicle 200.

The sensor system 202 may be mounted atop the vehicle 200 and may include one or more sensors configured to detect information about an environment surrounding the vehicle 200, and output indications of the information. For example, sensor system 202 can include any combination of cameras, radars, lidars, inertial sensors, humidity sensors, and acoustic sensors (e.g., microphones, sonar devices, etc.). The sensor system 202 can include one or more movable mounts that could be operable to adjust the orientation of one or more sensors in the sensor system 202. In one embodiment, the movable mount could include a rotating platform that could scan sensors so as to obtain information from each direction around the vehicle 200. In another embodiment, the movable mount of the sensor system 202 could be movable in a scanning fashion within a particular range of angles and/or azimuths and/or elevations. The sensor system 202 could be mounted atop the roof of a car, although other mounting locations are possible.

Additionally, the sensors of sensor system 202 could be distributed in different locations and need not be collocated in a single location. Furthermore, each sensor of sensor system 202 can be configured to be moved or scanned independently of other sensors of sensor system 202. Additionally or alternatively, multiple sensors may be mounted at one or more of the sensor locations 202, 204, 206, 208, 210, 212, 214, and/or 218. For example, there may be two lidar devices mounted at a sensor location and/or there may be one lidar device and one radar mounted at a sensor location.

The one or more sensor systems 202, 204, 206, 208, 210, 212, 214, and/or 218 could include one or more lidar sensors. For example, the lidar sensors could include a plurality of light-emitter devices arranged over a range of angles with respect to a given plane (e.g., the x-y plane, etc.). For example, one or more of the sensor systems 202, 204, 206, 208, 210, 212, 214, and/or 218 may be configured to rotate or pivot about an axis (e.g., the z-axis, etc.) perpendicular to the given plane so as to illuminate an environment surrounding the vehicle 200 with light pulses. Based on detecting various aspects of reflected light pulses (e.g., the elapsed time of flight, polarization, intensity, etc.), information about the surrounding environment may be determined.

In an example embodiment, sensor systems 202, 204, 206, 208, 210, 212, 214, and/or 218 may be configured to provide respective point cloud information that may relate to physical objects within the surrounding environment of the vehicle 200. While vehicle 200 and sensor systems 202, 204, 206, 208, 210, 212, 214, and 218 are illustrated as including certain features, it will be understood that other types of sensor systems are contemplated within the scope of the present disclosure. Further, the example vehicle 200 can include any of the components described in connection with vehicle 100 of FIG. 1.

In an example configuration, one or more radars can be located on vehicle 200. Similar to radar 126 described above, the one or more radars may include antennas configured to transmit and receive radio waves (e.g., electromagnetic waves having frequencies between 30 Hz and 300 GHz, etc.). Such radio waves may be used to determine the distance to and/or velocity of one or more objects in the surrounding environment of the vehicle 200. For example, one or more sensor systems 202, 204, 206, 208, 210, 212, 214, and/or 218 could include one or more radars. In some examples, one or more radars can be located near the rear of the vehicle 200 (e.g., sensor systems 208, 210, etc.), to actively scan the environment near the back of the vehicle 200 for the presence of radio-reflective objects. Similarly, one or more radars can be located near the front of the vehicle 200 (e.g., sensor systems 212, 214, etc.) to actively scan the environment near the front of the vehicle 200. A radar can be situated, for example, in a location suitable to illuminate a region including a forward-moving path of the vehicle 200 without occlusion by other features of the vehicle 200. For example, a radar can be embedded in and/or mounted in or near the front bumper, front headlights, cowl, and/or hood, etc. Furthermore, one or more additional radars can be located to actively scan the side and/or rear of the vehicle 200 for the presence of radio-reflective objects, such as by including such devices in or near the rear bumper, side panels, rocker panels, and/or undercarriage, etc.

The vehicle 200 can include one or more cameras. For example, the one or more sensor systems 202, 204, 206, 208, 210, 212, 214, and/or 218 could include one or more cameras. The camera can be a photosensitive instrument, such as a still camera, a video camera, a thermal imaging camera, a stereo camera, a night vision camera, etc., that is configured to capture a plurality of images of the surrounding environment of the vehicle 200. To this end, the camera can be configured to detect visible light, and can additionally or alternatively be configured to detect light from other portions of the spectrum, such as infrared or ultraviolet light. The camera can be a two-dimensional detector, and can optionally have a three-dimensional spatial range of sensitivity. In some embodiments, the camera can include, for example, a range detector configured to generate a two-dimensional image indicating distance from the camera to a number of points in the surrounding environment. To this end, the camera may use one or more range detecting techniques. For example, the camera can provide range information by using a structured light technique in which the vehicle 200 illuminates an object in the surrounding environment with a predetermined light pattern, such as a grid or checkerboard pattern and uses the camera to detect a reflection of the predetermined light pattern from environmental surroundings. Based on distortions in the reflected light pattern, the vehicle 200 can determine the distance to the points on the object. The predetermined light pattern may comprise infrared light, or radiation at other suitable wavelengths for such measurements. In some examples, the camera can be mounted inside a front windshield of the vehicle 200. Specifically, the camera can be situated to capture images from a forward-looking view with respect to the orientation of the vehicle 200. Other mounting locations and viewing angles of the camera can also be used, either inside or outside the vehicle 200. Further, the camera can have associated optics operable to provide an adjustable field of view. Still further, the camera can be mounted to vehicle 200 with a movable mount to vary a pointing angle of the camera, such as via a pan/tilt mechanism.

The vehicle 200 may also include one or more acoustic sensors (e.g., one or more of the sensor systems 202, 204, 206, 208, 210, 212, 214, 216, 218 may include one or more acoustic sensors, etc.) used to sense a surrounding environment of vehicle 200. Acoustic sensors may include microphones (e.g., piezoelectric microphones, condenser microphones, ribbon microphones, microelectromechanical systems (MEMS) microphones, etc.) used to sense acoustic waves (i.e., pressure differentials) in a fluid (e.g., air, etc.) of the environment surrounding the vehicle 200. Such acoustic sensors may be used to identify sounds in the surrounding environment (e.g., sirens, human speech, animal sounds, alarms, etc.) upon which control strategy for vehicle 200 may be based. For example, if the acoustic sensor detects a siren (e.g., an ambulatory siren, a fire engine siren, etc.), vehicle 200 may slow down and/or navigate to the edge of a roadway.

Although not shown in FIGS. 2A-2E, the vehicle 200 can include a wireless communication system (e.g., similar to the wireless communication system 146 of FIG. 1 and/or in addition to the wireless communication system 146 of FIG. 1, etc.). The wireless communication system may include wireless transmitters and receivers that could be configured to communicate with devices external or internal to the vehicle 200. Specifically, the wireless communication system could include transceivers configured to communicate with other vehicles and/or computing devices, for instance, in a vehicular communication system or a roadway station. Examples of such vehicular communication systems include DSRC, radio frequency identification (RFID), and other proposed communication standards directed towards intelligent transport systems.

The vehicle 200 may include one or more other components in addition to or instead of those shown. The additional components may include electrical or mechanical functionality.

A control system of the vehicle 200 may be configured to control the vehicle 200 in accordance with a control strategy from among multiple possible control strategies. The control system may be configured to receive information from sensors coupled to the vehicle 200 (on or off the vehicle 200), modify the control strategy (and an associated driving behavior) based on the information, and control the vehicle 200 in accordance with the modified control strategy. The control system further may be configured to monitor the information received from the sensors, and continuously evaluate driving conditions; and also may be configured to modify the control strategy and driving behavior based on changes in the driving conditions. For example, a route taken by a vehicle from one destination to another may be modified based on driving conditions. Additionally or alternatively, the velocity, acceleration, turn angle, follow distance (i.e., distance to a vehicle ahead of the present vehicle), lane selection, etc. could all be modified in response to changes in the driving conditions.

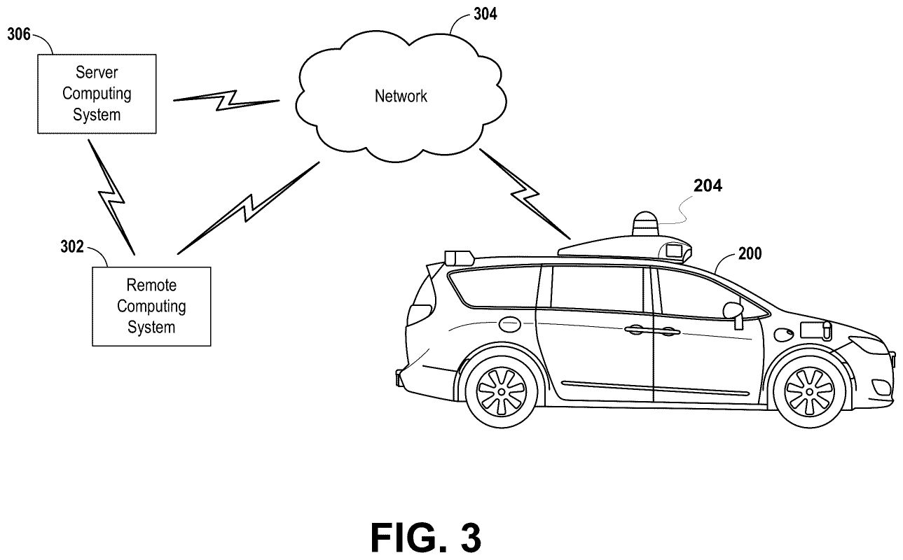

FIG. 3 is a conceptual illustration of wireless communication between various computing systems related to an autonomous or semi-autonomous vehicle, according to example embodiments. In particular, wireless communication may occur between remote computing system 302 and vehicle 200 via network 304. Wireless communication may also occur between server computing system 306 and remote computing system 302, and between server computing system 306 and vehicle 200.

Vehicle 200 can correspond to various types of vehicles capable of transporting passengers or objects between locations, and may take the form of any one or more of the vehicles discussed above. In some instances, vehicle 200 may operate in an autonomous or semi-autonomous mode that enables a control system to safely navigate vehicle 200 between destinations using sensor measurements. When operating in an autonomous or semi-autonomous mode, vehicle 200 may navigate with or without passengers. As a result, vehicle 200 may pick up and drop off passengers between desired destinations.

Remote computing system 302 may represent any type of device related to remote assistance techniques, including but not limited to those described herein. Within examples, remote computing system 302 may represent any type of device configured to (i) receive information related to vehicle 200, (ii) provide an interface through which a human operator can in turn perceive the information and input a response related to the information, and (iii) transmit the response to vehicle 200 or to other devices. Remote computing system 302 may take various forms, such as a workstation, a desktop computer, a laptop, a tablet, a mobile phone (e.g., a smart phone, etc.), and/or a server. In some examples, remote computing system 302 may include multiple computing devices operating together in a network configuration.

Remote computing system 302 may include one or more subsystems and components similar or identical to the subsystems and components of vehicle 200. At a minimum, remote computing system 302 may include a processor configured for performing various operations described herein. In some embodiments, remote computing system 302 may also include a user interface that includes input/output devices, such as a touchscreen and a speaker. Other examples are possible as well.

Network 304 represents infrastructure that enables wireless communication between remote computing system 302 and vehicle 200. Network 304 also enables wireless communication between server computing system 306 and remote computing system 302, and between server computing system 306 and vehicle 200.

The position of remote computing system 302 can vary within examples. For instance, remote computing system 302 may have a remote position from vehicle 200 that has a wireless communication via network 304. In another example, remote computing system 302 may correspond to a computing device within vehicle 200 that is separate from vehicle 200, but with which a human operator can interact while a passenger or driver of vehicle 200. In some examples, remote computing system 302 may be a computing device with a touchscreen operable by the passenger of vehicle 200.

In some embodiments, operations described herein that are performed by remote computing system 302 may be additionally or alternatively performed by vehicle 200 (i.e., by any system(s) or subsystem(s) of vehicle 200). In other words, vehicle 200 may be configured to provide a remote assistance mechanism with which a driver or passenger of the vehicle can interact.

Server computing system 306 may be configured to wirelessly communicate with remote computing system 302 and vehicle 200 via network 304 (or perhaps directly with remote computing system 302 and/or vehicle 200). Server computing system 306 may represent any computing device configured to receive, store, determine, and/or send information relating to vehicle 200 and the remote assistance thereof. As such, server computing system 306 may be configured to perform any operation(s), or portions of such operation(s), that is/are described herein as performed by remote computing system 302 and/or vehicle 200. Some embodiments of wireless communication related to remote assistance may utilize server computing system 306, while others may not.

Server computing system 306 may include one or more subsystems and components similar or identical to the subsystems and components of remote computing system 302 and/or vehicle 200, such as a processor configured for performing various operations described herein, and a wireless communication interface for receiving information from, and providing information to, remote computing system 302 and vehicle 200.

The various systems described above may perform various operations. These operations and related features will now be described.

In line with the discussion above, a computing system (e.g., remote computing system 302, server computing system 306, a computing system local to vehicle 200, etc.) may operate to use a camera to capture images of the surrounding environment of an autonomous or semi-autonomous vehicle. In general, at least one computing system will be able to analyze the images and possibly control the autonomous or semi-autonomous vehicle.

In some embodiments, to facilitate autonomous or semi-autonomous operation, a vehicle (e.g., vehicle 200, etc.) may receive data representing objects in an environment surrounding the vehicle (also referred to herein as “environment data”) in a variety of ways. A sensor system on the vehicle may provide the environment data representing objects of the surrounding environment. For example, the vehicle may have various sensors, including a camera, a radar, a lidar, a microphone, a radio unit, and other sensors. Each of these sensors may communicate environment data to a processor in the vehicle about information each respective sensor receives.

In one example, a camera may be configured to capture still images and/or video. In some embodiments, the vehicle may have more than one camera positioned in different orientations. Also, in some embodiments, the camera may be able to move to capture images and/or video in different directions. The camera may be configured to store captured images and video to a memory for later processing by a processing system of the vehicle. The captured images and/or video may be the environment data. Further, the camera may include an image sensor as described herein.

In another example, a radar may be configured to transmit an electromagnetic signal that will be reflected by various objects near the vehicle, and then capture electromagnetic signals that reflect off the objects. The captured reflected electromagnetic signals may enable the radar (or processing system) to make various determinations about objects that reflected the electromagnetic signal. For example, the distances to and positions of various reflecting objects may be determined. In some embodiments, the vehicle may have more than one radar in different orientations. The radar may be configured to store captured information to a memory for later processing by a processing system of the vehicle. The information captured by the radar may be environment data.

In another example, a lidar may be configured to transmit an electromagnetic signal (e.g., infrared light, such as that from a gas or diode laser, or other possible light source) that will be reflected by target objects near the vehicle. The lidar may be able to capture the reflected electromagnetic (e.g., infrared light, etc.) signals. The captured reflected electromagnetic signals may enable the range-finding system (or processing system) to determine a range to various objects. The lidar may also be able to determine a velocity or speed of target objects and store it as environment data.

Additionally, in an example, a microphone may be configured to capture audio of the environment surrounding the vehicle. Sounds captured by the microphone may include emergency vehicle sirens and the sounds of other vehicles. For example, the microphone may capture the sound of the siren of an ambulance, fire engine, or police vehicle. A processing system may be able to identify that the captured audio signal is indicative of an emergency vehicle. In another example, the microphone may capture the sound of an exhaust of another vehicle, such as that from a motorcycle. A processing system may be able to identify that the captured audio signal is indicative of a motorcycle. The data captured by the microphone may form a portion of the environment data.

In yet another example, the radio unit may be configured to transmit an electromagnetic signal that may take the form of a Bluetooth signal, 802.11 signal, and/or other radio technology signal. The first electromagnetic radiation signal may be transmitted via one or more antennas located in a radio unit. Further, the first electromagnetic radiation signal may be transmitted with one of many different radio-signaling modes. However, in some embodiments it is desirable to transmit the first electromagnetic radiation signal with a signaling mode that requests a response from devices located near the autonomous or semi-autonomous vehicle. The processing system may be able to detect nearby devices based on the responses communicated back to the radio unit and use this communicated information as a portion of the environment data.

In some embodiments, the processing system may be able to combine information from the various sensors in order to make further determinations of the surrounding environment of the vehicle. For example, the processing system may combine data from both radar information and a captured image to determine if another vehicle or pedestrian is in front of the autonomous or semi-autonomous vehicle. In other embodiments, other combinations of sensor data may be used by the processing system to make determinations about the surrounding environment.

While operating in an autonomous mode (or semi-autonomous mode), the vehicle may control its operation with little-to-no human input. For example, a human-operator may enter an address into the vehicle and the vehicle may then be able to drive, without further input from the human (e.g., the human does not have to steer or touch the brake/gas pedals, etc.), to the specified destination. Further, while the vehicle is operating autonomously or semi-autonomously, the sensor system may be receiving environment data. The processing system of the vehicle may alter the control of the vehicle based on environment data received from the various sensors. In some examples, the vehicle may alter a velocity of the vehicle in response to environment data from the various sensors. The vehicle may change velocity in order to avoid obstacles, obey traffic laws, etc. When a processing system in the vehicle identifies objects near the vehicle, the vehicle may be able to change velocity, or alter the movement in another way.

When the vehicle detects an object but is not highly confident in the detection of the object, the vehicle can request a human operator (or a more powerful computer) to perform one or more remote assistance tasks, such as (i) confirm whether the object is in fact present in the surrounding environment (e.g., if there is actually a stop sign or if there is actually no stop sign present, etc.), (ii) confirm whether the vehicle's identification of the object is correct, (iii) correct the identification if the identification was incorrect, and/or (iv) provide a supplemental instruction (or modify a present instruction) for the autonomous or semi-autonomous vehicle. Remote assistance tasks may also include the human operator providing an instruction to control operation of the vehicle (e.g., instruct the vehicle to stop at a stop sign if the human operator determines that the object is a stop sign, etc.), although in some scenarios, the vehicle itself may control its own operation based on the human operator's feedback related to the identification of the object.

To facilitate this, the vehicle may analyze the environment data representing objects of the surrounding environment to determine at least one object having a detection confidence below a threshold. A processor in the vehicle may be configured to detect various objects of the surrounding environment based on environment data from various sensors. For example, in one embodiment, the processor may be configured to detect objects that may be important for the vehicle to recognize. Such objects may include pedestrians, bicyclists, street signs, other vehicles, indicator signals on other vehicles, and other various objects detected in the captured environment data.

The detection confidence may be indicative of a likelihood that the determined object is correctly identified in the surrounding environment, or is present in the surrounding environment. For example, the processor may perform object detection of objects within image data in the received environment data, and determine that at least one object has the detection confidence below the threshold based on being unable to identify the object with a detection confidence above the threshold. If a result of an object detection or object recognition of the object is inconclusive, then the detection confidence may be low or below the set threshold.

The vehicle may detect objects of the surrounding environment in various ways depending on the source of the environment data. In some embodiments, the environment data may come from a camera and be image or video data. In other embodiments, the environment data may come from a lidar. The vehicle may analyze the captured image or video data to identify objects in the image or video data. The methods and apparatuses may be configured to monitor image and/or video data for the presence of objects of the surrounding environment. In other embodiments, the environment data may be radar, audio, or other data. The vehicle may be configured to identify objects of the surrounding environment based on the radar, audio, or other data.

In some embodiments, the techniques the vehicle uses to detect objects may be based on a set of known data. For example, data related to environmental objects may be stored to a memory located in the vehicle. The vehicle may compare received data to the stored data to determine objects. In other embodiments, the vehicle may be configured to determine objects based on the context of the data. For example, street signs related to construction may generally have an orange color. Accordingly, the vehicle may be configured to detect objects that are orange, and located near the side of roadways as construction-related street signs. Additionally, when the processing system of the vehicle detects objects in the captured data, it also may calculate a confidence for each object.

Further, the vehicle may also have a confidence threshold. The confidence threshold may vary depending on the type of object being detected. For example, the confidence threshold may be lower for an object that may require a quick responsive action from the vehicle, such as brake lights on another vehicle. However, in other embodiments, the confidence threshold may be the same for all detected objects. When the confidence associated with a detected object is greater than the confidence threshold, the vehicle may assume the object was correctly recognized and responsively adjust the control of the vehicle based on that assumption.

When the confidence associated with a detected object is less than the confidence threshold, the actions that the vehicle takes may vary. In some embodiments, the vehicle may react as if the detected object is present despite the low confidence level. In other embodiments, the vehicle may react as if the detected object is not present.

When the vehicle detects an object of the surrounding environment, it may also calculate a confidence associated with the specific detected object. The confidence may be calculated in various ways depending on the embodiment. In one example, when detecting objects of the surrounding environment, the vehicle may compare environment data to predetermined data relating to known objects. The closer the match between the environment data and the predetermined data, the higher the confidence. In other embodiments, the vehicle may use mathematical analysis of the environment data to determine the confidence associated with the objects.

In response to determining that an object has a detection confidence that is below the threshold, the vehicle may transmit, to the remote computing system, a request for remote assistance with the identification of the object. As discussed above, the remote computing system may take various forms. For example, the remote computing system may be a computing device within the vehicle that is separate from the vehicle, but with which a human operator can interact while a passenger or driver of the vehicle, such as a touchscreen interface for displaying remote assistance information. Additionally or alternatively, as another example, the remote computing system may be a remote computer terminal or other device that is located at a location that is not near the vehicle.

The request for remote assistance may include the environment data that includes the object, such as image data, audio data, etc. The vehicle may transmit the environment data to the remote computing system over a network (e.g., network 304, etc.), and in some embodiments, via a server (e.g., server computing system 306, etc.). The human operator of the remote computing system may in turn use the environment data as a basis for responding to the request.

In some embodiments, when the object is detected as having a confidence below the confidence threshold, the object may be given a preliminary identification, and the vehicle may be configured to adjust the operation of the vehicle in response to the preliminary identification. Such an adjustment of operation may take the form of stopping the vehicle, switching the vehicle to a human-controlled mode, changing a velocity of the vehicle (e.g., a speed and/or direction, etc.), among other possible adjustments.

In other embodiments, even if the vehicle detects an object having a confidence that meets or exceeds the threshold, the vehicle may operate in accordance with the detected object (e.g., come to a stop if the object is identified with high confidence as a stop sign, etc.), but may be configured to request remote assistance at the same time as (or at a later time from) when the vehicle operates in accordance with the detected object.

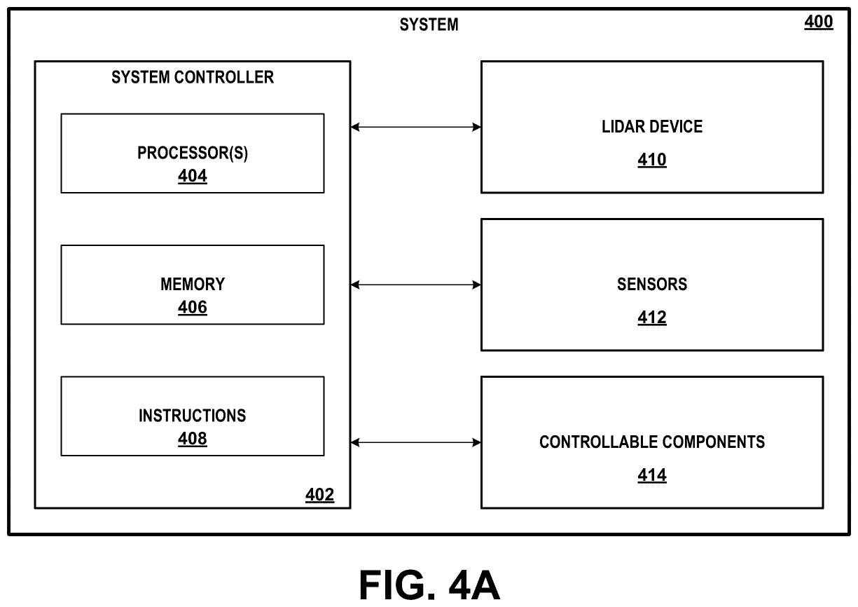

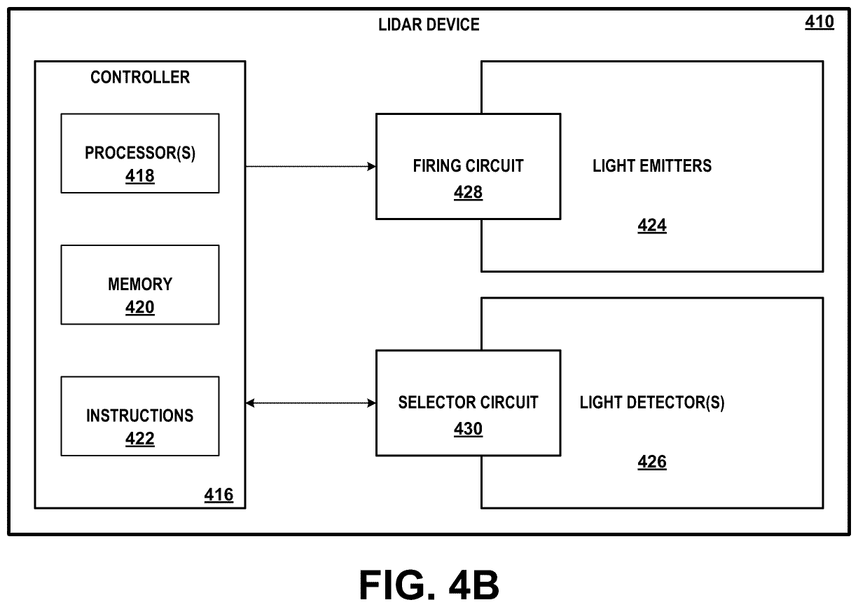

FIG. 4A is a block diagram of a system, according to example embodiments. In particular, FIG. 4A shows a system 400 that includes a system controller 402, a lidar device 410, a plurality of sensors 412, and a plurality of controllable components 414. System controller 402 includes processor(s) 404, a memory 406, and instructions 408 stored on the memory 406 and executable by the processor(s) 404 to perform functions.

The processor(s) 404 can include one or more processors, such as one or more general-purpose microprocessors (e.g., having a single core or multiple cores, etc.) and/or one or more special purpose microprocessors. The one or more processors may include, for instance, one or more central processing units (CPUs), one or more microcontrollers, one or more graphical processing units (GPUs), one or more tensor processing units (TPUs), one or more ASICs, and/or one or more field-programmable gate arrays (FPGAs). Other types of processors, computers, or devices configured to carry out software instructions are also contemplated herein.

The memory 406 may include a computer-readable medium, such as a non-transitory, computer-readable medium, which may include without limitation, read-only memory (ROM), programmable read-only memory (PROM), erasable programmable read-only memory (EPROM), electrically erasable programmable read-only memory (EEPROM), non-volatile random-access memory (e.g., flash memory, etc.), a solid state drive (SSD), a hard disk drive (HDD), a Compact Disc (CD), a Digital Video Disk (DVD), a digital tape, read/write (R/W) CDs, R/W DVDs, etc.

The lidar device 410, described further below, includes a plurality of light emitters configured to emit light (e.g., in light pulses, etc.) and one or more light detectors configured to detect light (e.g., reflected portions of the light pulses, etc.). The lidar device 410 may generate three-dimensional (3D) point cloud data from outputs of the light detector(s), and provide the 3D point cloud data to the system controller 402. The system controller 402, in turn, may perform operations on the 3D point cloud data to determine the characteristics of a surrounding environment (e.g., relative positions of objects within a surrounding environment, edge detection, object detection, proximity sensing, etc.).

Similarly, the system controller 402 may use outputs from the plurality of sensors 412 to determine the characteristics of the system 400 and/or characteristics of the surrounding environment. For example, the sensors 412 may include one or more of a GPS, an IMU, an image capture device (e.g., a camera, etc.), a light sensor, a heat sensor, and other sensors indicative of parameters relevant to the system 400 and/or the surrounding environment. The lidar device 410 is depicted as separate from the sensors 412 for purposes of example, and may be considered as part of or as the sensors 412 in some examples.

Based on characteristics of the system 400 and/or the surrounding environment determined by the system controller 402 based on the outputs from the lidar device 410 and the sensors 412, the system controller 402 may control the controllable components 414 to perform one or more actions. For example, the system 400 may correspond to a vehicle, in which case the controllable components 414 may include a braking system, a turning system, and/or an accelerating system of the vehicle, and the system controller 402 may change aspects of these controllable components based on characteristics determined from the lidar device 410 and/or sensors 412 (e.g., when the system controller 402 controls the vehicle in an autonomous or semi-autonomous mode, etc.). Within examples, the lidar device 410 and the sensors 412 are also controllable by the system controller 402.

FIG. 4B is a block diagram of a lidar device, according to an example embodiment. In particular, FIG. 4B shows a lidar device 410, having a controller 416 configured to control a plurality of light emitters 424 and one or more light detector(s), e.g., a plurality of light detectors 426, etc. The lidar device 410 further includes a firing circuit 428 configured to select and provide power to respective light emitters of the plurality of light emitters 424 and may include a selector circuit 430 configured to select respective light detectors of the plurality of light detectors 426. The controller 416 includes processor(s) 418, a memory 420, and instructions 422 stored on the memory 420.

Similar to processor(s) 404, the processor(s) 418 can include one or more processors, such as one or more general-purpose microprocessors and/or one or more special purpose microprocessors. The one or more processors may include, for instance, one or more CPUs, one or more microcontrollers, one or more GPUs, one or more TPUs, one or more ASICs, and/or one or more FPGAs. Other types of processors, computers, or devices configured to carry out software instructions are also contemplated herein.

Similar to memory 406, the memory 420 may include a computer-readable medium, such as a non-transitory, computer-readable medium, such as, but not limited to, ROM, PROM, EPROM, EEPROM, non-volatile random-access memory (e.g., flash memory, etc.), a SSD, a HDD, a CD, a DVD, a digital tape, R/W CDs, R/W DVDs, etc.

The instructions 422 are stored on memory 420 and executable by the processor(s) 418 to perform functions related to controlling the firing circuit 428 and the selector circuit 430, for generating 3D point cloud data, and for processing the 3D point cloud data (or perhaps facilitating processing the 3D point cloud data by another computing device, such as the system controller 402).

The controller 416 can determine 3D point cloud data by using the light emitters 424 to emit pulses of light. A time of emission is established for each light emitter and a relative location at the time of emission is also tracked. Aspects of a surrounding environment of the lidar device 410, such as various objects, reflect the pulses of light. For example, when the lidar device 410 is in a surrounding environment that includes a road, such objects may include vehicles, signs, pedestrians, road surfaces, construction cones, etc. Some objects may be more reflective than others, such that an intensity of reflected light may indicate a type of object that reflects the light pulses. Further, surfaces of objects may be at different positions relative to the lidar device 410, and thus take more or less time to reflect portions of light pulses back to the lidar device 410. Accordingly, the controller 416 may track a detection time at which a reflected light pulse is detected by a light detector and a relative position of the light detector at the detection time. By measuring time differences between emission times and detection times, the controller 416 can determine how far the light pulses travel prior to being received, and thus a relative distance of a corresponding object. By tracking relative positions at the emission times and detection times the controller 416 can determine an orientation of the light pulse and reflected light pulse relative to the lidar device 410, and thus a relative orientation of the object. By tracking intensities of received light pulses, the controller 416 can determine how reflective the object is. The 3D point cloud data determined based on this information may thus indicate relative positions of detected reflected light pulses (e.g., within a coordinate system, such as a Cartesian coordinate system, etc.) and intensities of each reflected light pulse.

The firing circuit 428 is used for selecting light emitters for emitting light pulses. The selector circuit 430 similarly is used for sampling outputs from light detectors.

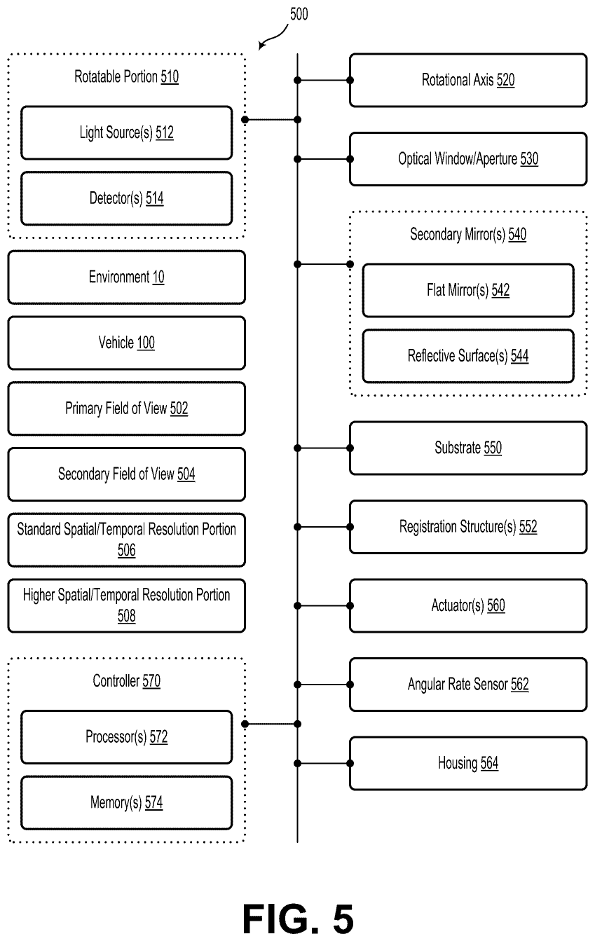

FIG. 5 is a block diagram of a lidar system 500, according to example embodiments. It will be understood that lidar system 500 could be similar or identical to lidar system 128, sensor system 204, lidar device 410, as illustrated and described in reference to FIGS. 1, 2A-2E, 3, 4A, and 4B.

The lidar system 500 includes a rotatable portion 510. The rotatable portion 510 could include one or more light sources 512. The light sources 512 could include laser diodes or another type of light source configured to emit light into an environment 10 of a vehicle (e.g., vehicle 100).

The rotatable portion 510 also includes one or more detectors 514. The detectors 514 could include photodetector devices such as avalanche photodiodes (APDs), silicon photomultiplier (SiPM), among other examples.

In such scenarios, the rotatable portion 510 is configured to rotate about a rotational axis 520 such that the one or more light sources 512 are operable to emit light within an azimuthal 360 degree field of view. In example embodiments, the 360 degree field of view includes a primary field of view 502 that is less than 360 degrees in azimuth.

It will be understood that other geometries of the rotatable portion 510 are possible and contemplated. For example, the rotatable portion 510 could be configured to rotate about a substantially horizontal rotational axis 520. In such a scenario, the light sources 512 and detectors 514 could be rotated so as to progressively scan different vertical elevation angles.

The lidar system 500 also includes at least one secondary mirror 540 configured to reflect light initially emitted by the one or more light sources 512 in a direction away from the primary field of view 502 so as to redirect the light into a secondary field of view 504.

In example embodiments, the primary field of view 502 and the secondary field of view 504 may at least partially overlap so as to provide a higher spatial resolution and/or temporal resolution portion 508 of the primary field of view 502 (e.g., where the primary field of view 502 and the secondary field of view 504 overlap).

As an example, the primary field of view 502 and the secondary field of view 504 could be spatially interlaced. For example, a first group of scan lines provided while the lidar scans through a primary azimuthal range could be vertically interlaced with a second group of scan lines provided while the lidar scans through a secondary azimuthal range. Further groups of scan lines could be vertically interlaced with the other scan lines. Accordingly, higher spatial resolution and/or higher temporal resolution lidar information could be provided by lidar system 500.

In example embodiments, the higher resolution portion 508 of the primary field of view 502 could provide a spatial resolution that is at least three times a spatial resolution of a standard resolution portion 506 of the primary field of view 502.

In some examples, the primary field of view 502 could be defined, at least in part, by an optical path, an optical window, and/or an optical aperture 530. As one possibility, the primary field of view 502 could correspond to a forward-facing field of view from vehicle 100.

The primary field of view 502 could be oriented in other directions (e.g., backward-facing, side-facing, etc.) with respect to the vehicle 100. In various examples, the primary field of view 502 could be statically defined with respect to the vehicle 100. In an example embodiment, the primary field of view 502 could include an azimuthal angle range of between 100 and 140 degrees in azimuth. However, it will be understood that other azimuthal angle ranges are possible for the primary field of view.

Additionally or alternatively, the higher resolution portion 508 of the field of view could include an azimuthal angle range of between 5 and 45 degrees in azimuth.

In some scenarios, the higher resolution portion 508 of the field of view is disposed within a central portion of the primary field of view 502.

In various examples, the lidar system 500 may include a housing 564. In such scenarios, the housing 564 is configured to be mounted to an interior portion of a vehicle 12. As an example, the interior portion of the vehicle 12 could include an interior surface of a windshield of the vehicle 12. In various examples, the housing 564 could provide a compact housing for some or all of the components of lidar system 500. In such scenarios, the housing 564 could include a plastic enclosure that could be mounted behind a location of a conventional rear-view mirror (e.g., along an upper-center interior surface of a windshield).

In some examples, the lidar system 500 may also include a substrate 550. In such scenarios, the rotatable portion 510 and the at least one secondary mirror 540 are operably attached to the substrate 550 by way of one or more registration structures 552. In some examples, the registration structures 552 could include one or more pins, posts, slots, grooves, or holes configured to provide repeatable and reliable alignment of parts with respect to one another.

In various embodiments, the at least one secondary mirror 540 includes a flat mirror 542. In such scenarios, a reflective surface 544 of the at least one secondary mirror 540 could be arranged substantially parallel to the rotational axis 520. While flat mirror 542 is described herein, it will be understood that other types of reflective optical devices are possible and contemplated. For example, planar, cylindrical, spherical, convex, and concave reflective optical devices could be utilized in lidar system 500. Yet further, the reflective layer of flat mirror 542 and/or other reflective optical devices could include a metal such as silver, tin, nickel and/or chromium. Additionally or alternatively, the reflective layer could include a dielectric stack.

In some examples, the lidar system 500 may additionally include at least one actuator 560. The actuator 560 is configured to adjust a position of the at least one secondary mirror 540. In some examples, the actuator 560 could include a mechanical actuator, a piezoelectric actuator, a hydraulic cylinder, a pneumatic actuator, a screw jack, a solenoid, a micromirror actuator, a capacitive comb drive, a stepper motor, a voice coil, or another type of controllable actuator.

In example embodiments, the lidar system could also include a controller 570. The controller 570 could include at least one processor 572 and a memory 574. The controller 570 is configured to execute instructions stored in the memory so as to carry out certain operations.

In some cases, the operations may include causing the at least one actuator 560 to adjust the position of the at least one secondary mirror 540 so as to adjust a position of the secondary field of view 504 with respect to the primary field of view 502.

Additionally or alternatively, the lidar system 500 may include an angular rate sensor 562 configured to provide information indicative of a motion (e.g., of the lidar system 500 and/or a body to which the lidar system 500 is attached). In such scenarios, the operations could also include receiving the information indicative of a motion (e.g., tilting, turning, vibration, etc.). In response, the operations could include causing the at least one actuator 560 to adjust the position of the at least one secondary mirror 540 based on the received information so as to at least partially counteract the motion. That is, the angular rate sensor 562 could provide information to the controller 570 so as to actively adjust the position of the secondary field of view 504 so as to reduce the effects of vibration, vehicle motion, and/or other types of motion.

In some embodiments, the controller 570 could be configured to carry out other operations such as receiving information indicative of an object in an environment, wherein causing the at least one actuator to adjust the position of the at least one secondary mirror is based on the object in the environment so as to scan the object with the higher resolution portion of the primary field of view.

In various examples, the operations could additionally or alternatively include receiving information indicative of an orientation of the lidar system 500. In such scenarios, in response, the controller 570 could cause the at least one actuator 560 to adjust the position of the at least one secondary mirror 540 based on the orientation of the lidar system 500. In various embodiments, the orientation of the lidar system 500 could be provided by way of an inertial measurement unit (IMU), global positioning system (GPS), gyroscope, or another type of orientation sensor.

It will be understood that lidar system 500 could be configured to be incorporated into a vehicle (e.g., vehicle 100). Additionally or alternatively, lidar system 500 could take the form of a lidar module with a housing 564 configured to be attached to a vehicle. In such scenarios, the elements of lidar system 500 could be substantially contained within the housing 564.

In such scenarios, the housing 564 could be configured to be attached to a windshield of the vehicle 100. For example, the lidar module and/or the housing 564 could be attached to an interior surface of the windshield so that the primary field of view 502 may be oriented in a forward-facing direction with respect to the vehicle 100. It will be understood that the lidar module and the housing 564 could be configured to be attached to other surfaces of the vehicle 100 such as a rear window, a vehicle roof, a roofline, a front grille area, a front hood, a top-mounted sensor unit, or another attachment point on the vehicle 100.

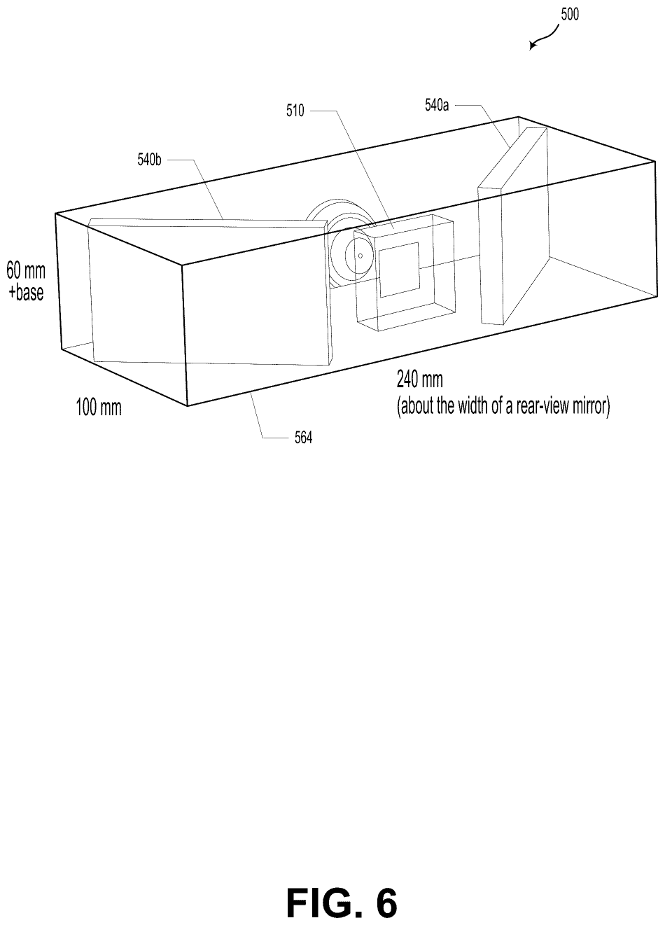

FIG. 6 is an illustration of the lidar system 500 of FIG. 5, according to example embodiments. As an example, lidar system 500 may include a housing 564 that may be approximately 60×100×240 millimeters in size. However, it will be understood that other sizes and form factors are possible and contemplated. In an example embodiment, the housing 564 could be formed from various materials such as plastic, metal, and/or ceramic materials. In some examples, the housing 564 could be formed from high-density polyethylene or polycarbonate. As illustrated in FIG. 6, the rotatable portion 510 and secondary mirrors 540a and 540b could be contained within the housing 564.

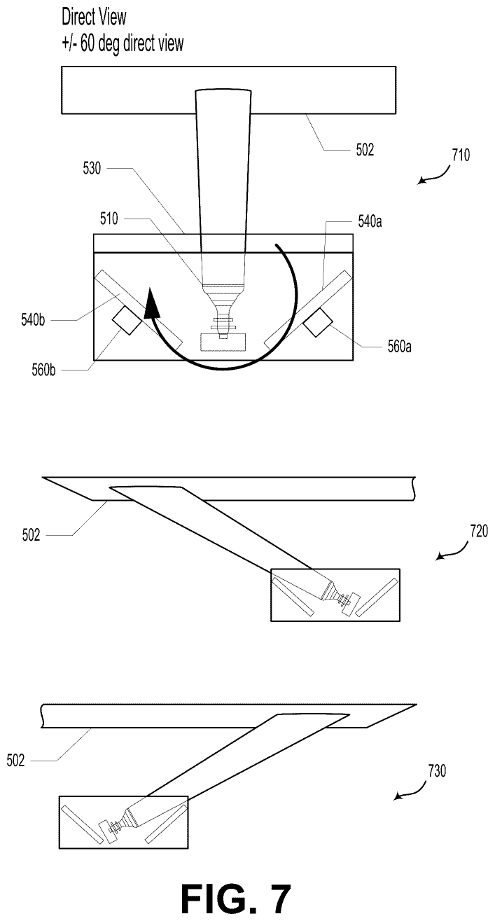

FIG. 7 is an illustration of a direct view operation of the lidar system 500 of FIG. 5, according to example embodiments. Scenarios 710, 720, and 730 illustrate (from an overhead perspective) different azimuthal orientations of the rotatable portion 510. Scenario 710 illustrates the rotatable portion 510 oriented toward the center of the primary field of view 502. Scenario 720 illustrates the rotatable portion 510 oriented toward the left side of the primary field of view 502. Scenario 730 illustrates the rotatable portion 510 oriented toward the right side of the primary field of view 502. In each of scenarios 710, 720, and 730, light emitted from and received by the lidar system 500 may pass directly through an optical window/aperture 530. As described in FIG. 7, the direct view operation could correspond to an approximately 120 degree primary field of view 502. It will be understood that the azimuthal and elevation angle extents of the primary field of view 502 could vary based on physical constraints, application and/or optical system considerations.

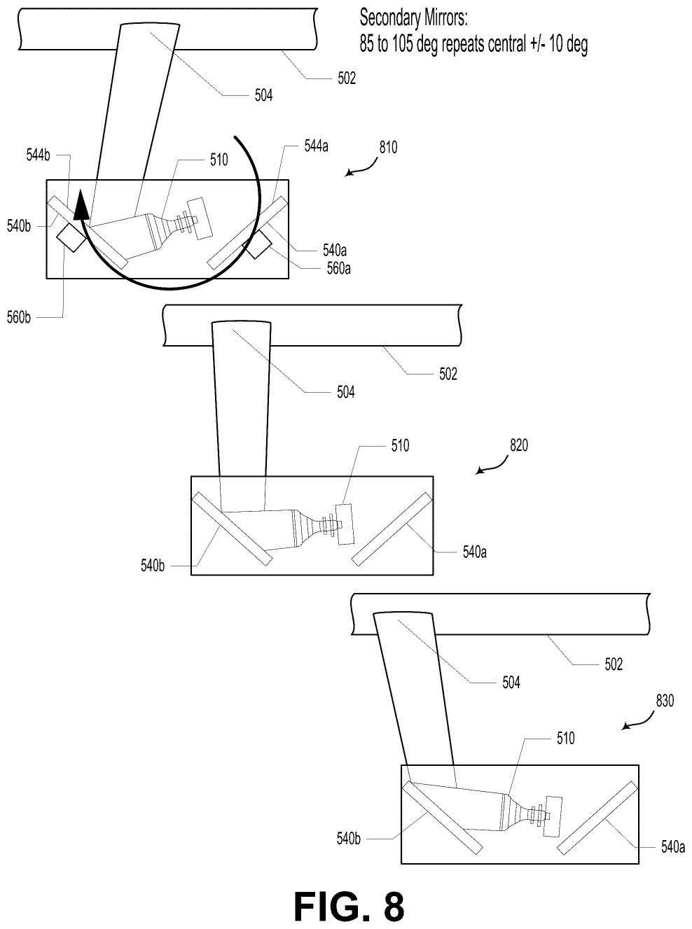

FIG. 8 is an illustration of secondary mirror operation of the lidar system 500 of FIG. 5, according to example embodiments. Scenarios 810, 820, and 830 illustrate (from an overhead perspective) different azimuthal orientations of the rotatable portion 510. Scenario 810 illustrates the rotatable portion 510 oriented toward a first portion of secondary mirror 540b. Light emitted from the rotatable portion 510 is reflected off of a reflective surface 544b so as to illuminate a portion of a secondary field of view 504. Scenario 820 illustrates the rotatable portion 510 oriented toward a second portion of the secondary mirror 540b. Scenario 830 illustrates the rotatable portion 510 oriented toward a third portion of the secondary mirror 540b. In each of scenarios 810, 820, and 830, light emitted from and received by the lidar system 500 passes through an optical window/aperture 530 by way of the secondary mirror 540b and reflective surface 544b. As illustrated in FIG. 8, as the rotatable portion 510 sweeps left-to-right across the secondary mirror 540b, the reflected beam sweeps right-to-left across the secondary field of view 504. Likewise, although not illustrated in FIG. 8, the rotatable portion 510 can rotate so as to direct light toward secondary mirror 540a and its respective reflective surface 544a. In such scenarios, the reflected light may form a beam that may sweep across the secondary field of view 504.

As illustrated in FIG. 8, the secondary mirrors 540a and 540b could be coupled to actuators 560a and 560b. Actuators 560a and 560b could be configured to adjust (e.g., tip/tilt) at least one orientation of the respective secondary mirrors. Adjusting the orientation of the secondary mirrors 540 could change the position of the secondary field of view 504 in the environment and with respect to the primary field of view 502.

It will be understood that FIGS. 7 and 8 are merely illustrative in nature and are not meant to be limiting. Other arrangements and/or design choices are possible and contemplated. For example, in an extreme version of scenario 810, a lens of the rotatable portion 510 could virtually touch or graze the secondary mirror 540b and/or 540a. Likewise, for scenario 830, the angle at which the beam fires into the environment 10 may be limited by the size of the secondary mirror 540a or 540b. In such a manner, the optical extents of the secondary field of view 504 could be maximized or otherwise adjusted based on the desired lidar resolution, lidar operating scenario, and physical constraints and dimensions of the housing 564, secondary mirrors 540, the size of the rotatable portion 510, among other possibilities. It will be understood that other optical and mechanical design considerations may be relevant to provide a compact, spinning lidar system with a portion of its field of view having a higher resolution than other portions of the field of view.

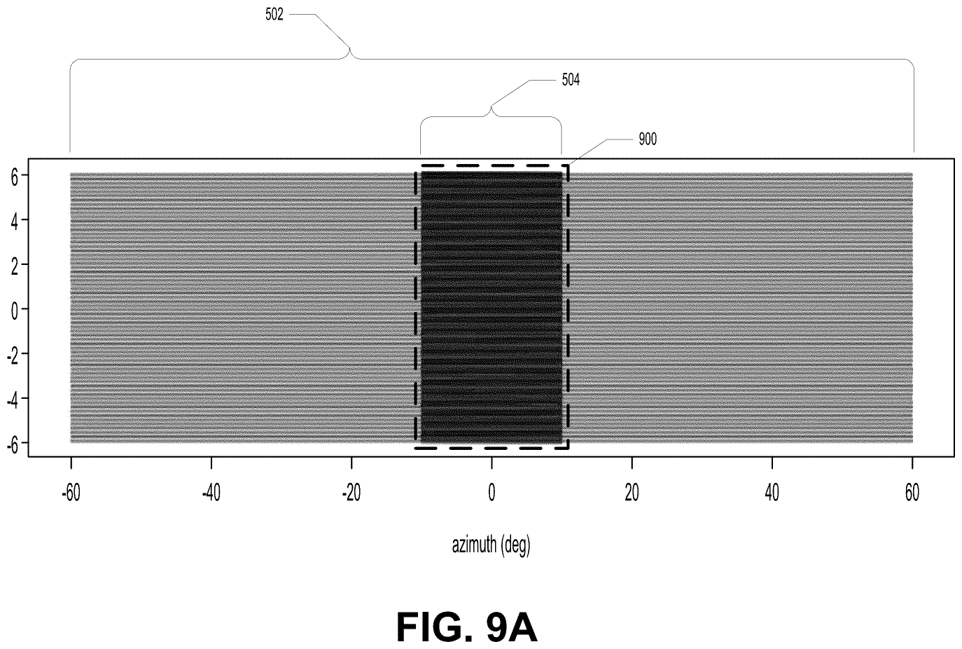

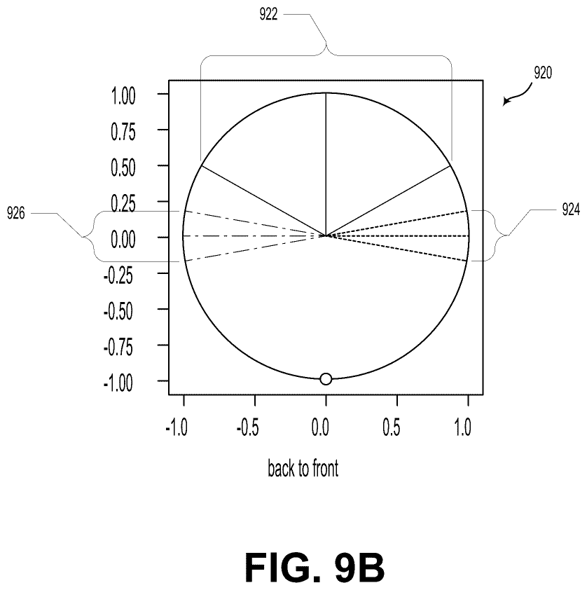

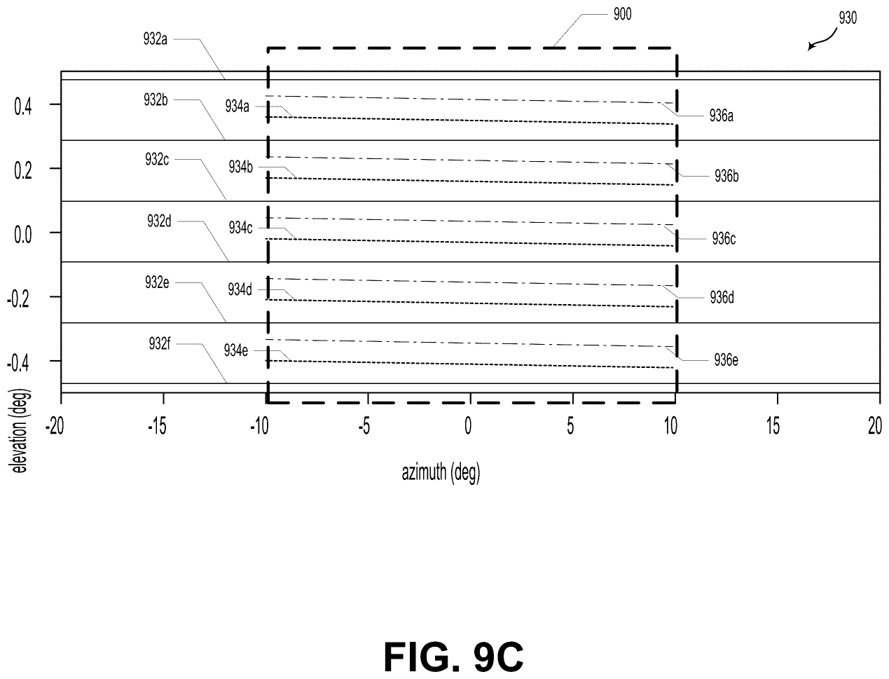

FIG. 9A is an illustration of a primary field of view 502 and an overlapping secondary field of view 504, according to example embodiments. As described herein, the primary field of view 502 could include an azimuthal angle range of approximately 120 degrees. Additionally or alternatively, the secondary field of view 504 could include an azimuthal angle range of approximately 20 degrees. It will be understood that other azimuthal angle ranges are possible and contemplated for the primary field of view 502 and the secondary field of view 504. The overlapping portions of the primary field of view 502 and the secondary field of view 504 could define an overlapping region 900. The overlapping region 900 could provide a higher spatial resolution and/or higher temporal resolution. In some examples, the overlapping region 900 could be directed toward a forward-facing region in front of a vehicle. However, it should be understood that the overlapping region 900 could be located in another region. Additionally or alternatively, the position of the overlapping region 900 could be dynamically adjustable by adjusting one or more actuators 560.

FIG. 9B is an overhead illustration 920 showing a plurality of azimuthal scanning regions of a spinning lidar (e.g., lidar system 500), according to example embodiments. As illustrated in FIG. 9B, a front-facing region 922 could define a primary field of view (e.g., primary field of view 502) with an azimuthal angle range of approximately 120 degrees. While oriented within the front-facing region 922, light emitted by the lidar system 500 could interact directly with the environment 10 by way of the optical window/aperture 530.

Additionally, by reflecting emitted light off of secondary mirrors 540a and 540b, the spinning lidar may utilize a left-facing region 926 (by reflecting emitted light off of secondary mirror 540b) and a right-facing region 924 (by reflecting emitted light off of secondary mirror 540a). In other words, while the rotatable portion 510 is oriented toward the left-facing region 926 or the right-facing region 924, emitted light interacts with secondary mirrors 540b and 540a before propagating toward the secondary field of view 504.

It will be understood that while various usable azimuthal scanning regions are illustrated in FIG. 9B, other regions and respective region sizes and region locations are contemplated and possible. For example, in some embodiments, the secondary mirrors need not be arranged in a symmetric fashion with respect to the primary field of view. Additionally or alternatively, although two secondary mirrors are illustrated in FIGS. 7 and 8, more or fewer than two secondary mirrors are possible and contemplated.

FIG. 9C represents a close-up view of FIG. 9A and is an illustration of light emitted into a primary field of view (e.g., primary field of view 502) and an overlapping secondary field of view (e.g., secondary field of view 504) versus azimuth angle, according to example embodiments. Referring to FIGS. 5, 7, 8, 9A, and 9B, as the rotatable portion 510 moves through the front-facing region 922, emitted light may be transmitted into the environment 10 into the primary field of view 502 along azimuthal scan lines 932a-932f. The family of azimuthal scan lines 932a-932f represents the locations within the primary field of view 502 that could progressively receive emitted light from a plurality of light sources 512 distributed along a vertical direction. While the rotatable portion 510 is oriented toward the left-facing region 926, the lidar system 500 could progressively illuminate the secondary field of view 504 along the family of azimuthal scan lines 936a-936e. While the rotatable portion 510 is oriented toward the right-facing region 924, the lidar system 500 could progressively illuminate the secondary field of view 504 along the family of azimuthal scan lines 934a-934e.

It will be understood that the secondary field of view 504 need not be contiguous and/or completely overlapping with the primary field of view 502. Furthermore, the respective sets of azimuthal scan lines (e.g., scan lines 936a-936e and scan lines 934a-934e) need not be directed toward substantially the same region of the field of view. Rather, the respective secondary mirrors (e.g., secondary mirror 540a and 540b) could be arranged and/or adjustable so as to form two or more different secondary fields of view with respect to the primary field of view 502. Other ways to direct the azimuthal scan lines with the secondary mirrors 540 are possible and contemplated so as to form one or more higher spatial/temporal resolution portions 508 within the primary field of view 502.

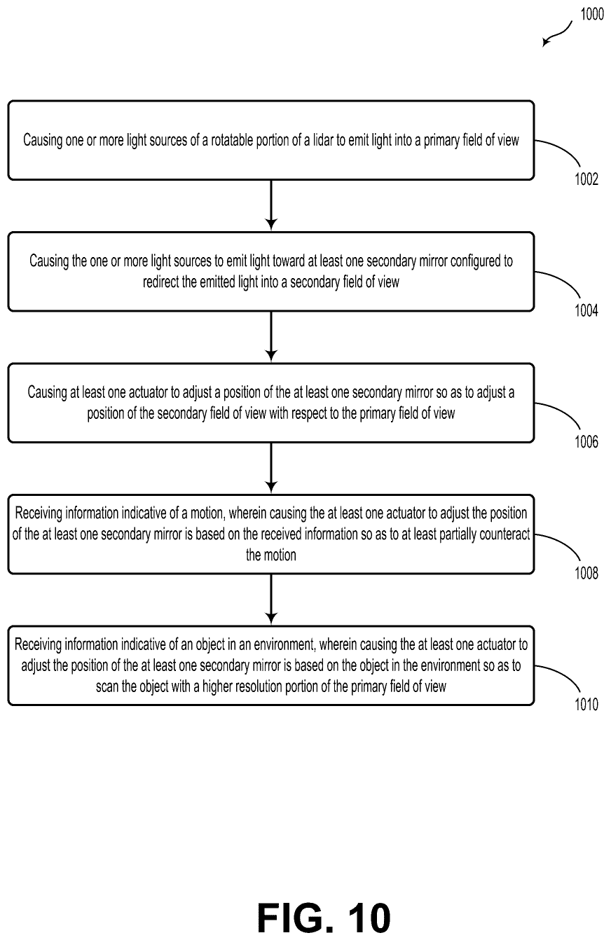

FIG. 10 is a flow chart depicting a method 1000, according to example embodiments. It will be understood that the method 1000 may include fewer or more steps or blocks than those expressly illustrated or otherwise disclosed herein. Furthermore, respective steps or blocks of method 1000 may be performed in any order and each step or block may be performed one or more times. In some embodiments, some or all of the blocks or steps of method 1000 may be carried out by controller 570 and/or other elements of lidar system 500, as illustrated and described in relation to FIG. 5.

Block 1002 includes causing one or more light sources (e.g., light source 512) of a rotatable portion (e.g., rotatable portion 510) of a lidar (e.g., lidar system 500) to emit light into a primary field of view (e.g., primary field of view 502).

Block 1004 includes causing the one or more light sources to emit light toward at least one secondary mirror (e.g., secondary mirror(s) 540) configured to redirect the emitted light into a secondary field of view (e.g., secondary field of view 504).

Block 1006 includes causing at least one actuator (e.g., actuator 560) to adjust a position of the at least one secondary mirror so as to adjust a position of the secondary field of view with respect to the primary field of view.

Block 1008 includes receiving information indicative of a motion. In such scenarios, causing the at least one actuator to adjust the position of the at least one secondary mirror could be based on the received information so as to at least partially counteract the motion.

Block 1010 includes receiving information indicative of an object in an environment (e.g., environment 10). In such scenarios, causing the at least one actuator to adjust the position of the at least one secondary mirror could be based on the object in the environment so as to scan the object with a higher resolution portion (e.g., higher spatial/temporal resolution portion 508) of the primary field of view.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A lidar system, comprising:
a rotatable portion, wherein the rotatable portion comprises:
one or more light sources; and
one or more detectors, wherein the rotatable portion is configured to rotate about a rotational axis such that the one or more light sources are operable to emit light within an azimuthal 360 degree field of view, wherein the 360 degree field of view comprises a primary field of view that is less than 360 degrees; and
at least one secondary mirror configured to reflect light initially emitted by the one or more light sources in a direction away from the primary field of view so as to redirect the light into a secondary field of view.

2. The lidar system of claim 1, wherein the primary field of view and the secondary field of view at least partially overlap so as to provide a higher resolution portion of the primary field of view, wherein the higher resolution portion comprises a higher spatial resolution and/or a higher temporal resolution compared to other portions of the primary field of view.

3. The lidar system of claim 2, wherein the primary field of view and the secondary field of view are spatially interlaced.

4. The lidar system of claim 2, wherein the higher resolution portion of the primary field of view comprises a spatial resolution that is at least three times a spatial resolution of a standard resolution portion of the primary field of view.

5. The lidar system of claim 2, wherein the primary field of view comprises between 100 and 140 degrees in azimuth.

6. The lidar system of claim 2, wherein the higher resolution portion of the primary field of view comprises between 5 and 45 degrees in azimuth.

7. The lidar system of claim 2, wherein the higher resolution portion of the primary field of view is disposed within a central portion of the primary field of view.

8. The lidar system of claim 1, further comprising a housing, wherein the housing is configured to be mounted to an interior portion of a vehicle.

9. The lidar system of claim 8, wherein the interior portion of a vehicle comprises an interior surface of a windshield of the vehicle.

10. The lidar system of claim 1, further comprising a substrate, wherein the rotatable portion and the at least one secondary mirror are operably attached to the substrate by way of one or more registration structures.

11. The lidar system of claim 1, wherein the at least one secondary mirror comprises a flat mirror.

12. The lidar system of claim 11, wherein a reflective surface of the at least one secondary mirror is arranged substantially parallel to the rotational axis.

13. The lidar system of claim 1, further comprising:
at least one actuator, wherein the actuator is configured to adjust a position of the at least one secondary mirror.

14. The lidar system of claim 13, further comprising:
a controller comprising at least one processor and a memory, wherein the controller is configured to execute instructions stored in the memory so as to carry out operations, the operations comprising:
causing the at least one actuator to adjust the position of the at least one secondary mirror so as to adjust a position of the secondary field of view with respect to the primary field of view.

15. The lidar system of claim 14, further comprising:
an angular rate sensor configured to provide information indicative of a motion, wherein the operations further comprise:
receiving the information indicative of a motion, wherein causing the at least one actuator to adjust the position of the at least one secondary mirror is based on the received information so as to at least partially counteract the motion.

16. The lidar system of claim 14, wherein the operations further comprise:
receiving information indicative of an object in an environment, wherein causing the at least one actuator to adjust the position of the at least one secondary mirror is based on the object in the environment so as to scan the object with a higher resolution portion of the primary field of view.

17. The lidar system of claim 14, wherein the operations further comprise:
receiving information indicative of an orientation of the lidar system, wherein causing the at least one actuator to adjust the position of the at least one secondary mirror is based on the orientation of the lidar system.

18. A lidar module, comprising:
a housing configured to be attached to a vehicle;
a rotatable portion disposed inside the housing, wherein the rotatable portion comprises:
one or more light sources; and
one or more detectors, wherein the rotatable portion is configured to rotate about a rotational axis such that the one or more light sources are operable to emit light within an azimuthal 360 degree field of view, wherein the 360 degree field of view comprises a primary field of view that is less than 360 degrees; and
at least one secondary mirror disposed inside the housing, wherein the at least one secondary mirror is configured to reflect light initially emitted by the one or more light sources in a direction outside the primary field of view so as to redirect the light into a secondary field of view.

19. The lidar module of claim 18, wherein the housing is configured to be attached to a windshield of the vehicle.

20. The lidar module of claim 18, further comprising:
at least one actuator, wherein the actuator is configured to adjust a position of the at least one secondary mirror; and
a controller comprising at least one processor and a memory, wherein the controller is configured to execute instructions stored in the memory so as to carry out operations, the operations comprising:
causing the at least one actuator to adjust the position of the at least one secondary mirror so as to adjust a position of the secondary field of view with respect to the primary field of view.
